(19) United States
(12) Patent Application Publication
(10) Pub. No.: US 2004/0103569 A1
(43) Pub. Date: Jun. 3, 2004

(54) Reusable reminder

(76) Inventors: Dorothy D'Angelo, Edison, NJ (US); Karen D'Angelo, Edison, NJ (US); Christine DePasquale, Metuchen, NJ (US)

Correspondence Address: KAPLAN & GILMAN , L.L.P., 900 ROUTE 9 NORTH, WOODBRIDGE, NJ, 07095, US

(21) Appl. No.: 10/722,342

(22) Filed: Nov. 25, 2003

Related U.S. Application Data
(60) Provisional application No. 60/439,939, filed on Jan. 14, 2003.
(60) Provisional application No. 60/428,879, filed on Nov. 25, 2002.

(51) Int. Cl. G09F 3/00

(52) U.S. Cl. 40/360; 40/674

(57) ABSTRACT

An economic and efficient reminder that records the status of an item and is reusable. The reusable reminder is formed with a bendable tab adjacent each position on a sheet. In another embodiment, the reusable reminder is provided with a coupon for the user to redeem. A plurality of the reminders of the present invention are also provided in the form of a pad, booklet or the like.

This application claims the benefit of the filing date of each of U.S. provisional patent applications Nos. 60/439,939, filed Jan. 14, 2003 and 60/428,879, filed Nov. 25, 2002, the entirety of each of which is incorporated herein by reference.

### FIELD OF THE INVENTION

The invention relates to reusable reminders, for example reminders used to note certain articles of daily use the supply of which requires replenishment and tasks to be performed.

### BACKGROUND OF THE INVENTION

Reminder lists are typically written on pieces of paper and when an item in the list has been acted upon it is lined through by a writing instrument. Reminder lists are typically used on a weekly or daily basis and often contain the same items from week to week or day to day. Such lists are typically disposed of upon completion of the list because once items are lined through the list is not usable. Since reminder lists often contain the same items from week to week a novel article for providing a reusable reminder not requiring a writing instrument to indicate an item is collected or a task completed is desirable.

### SUMMARY OF THE INVENTION

The invention provides an economic and efficient reminder that records the status of an item and is reusable. The reusable reminder is formed with a bendable tab adjacent each position on a sheet. In another embodiment, the reusable reminder may be provided with a coupon for the user to redeem. A plurality of the reminders of the present invention can also be provided in the form of a pad, booklet or the like.

### OBJECTS OF THE INVENTION

It is an object of the present invention to provide an article for reminding persons of the necessity of attending to certain matters listed on the article such as the purchase of household items, attending appointments or the like.

It is a further object of the present invention to provide a reminder that serves as a continuous reminder to the user that a particular item requires, purchase, attention or otherwise, which reminder will remain as such until the item or items have been attended by the user.

It is yet a further object of the present invention to provide a reminder that is reusable from day to day, week to week or the like.

It is still a further object of the present invention to provide a reminder article that is capable of simple and economical production and manufacture employing a minimum number of parts, as well as convenience and ease of use.

It is a further object of the present invention to provide a reusable reminder that does not require the use of a writing or other instrument to indicate an item has been purchased or a task completed.

It is still yet a further object of the present invention to provide a plurality of the reusable reminders in the form of a pad.

It is still a further object of the present invention to provide a reusable reminder or pad of such reminders which can be readily carried in a pocket or handbag.

It is another object of the present invention to provide a reusable reminder on which a redeemable coupon is provided.

It is a still additional object of the present invention to provide a reusable reminder in the form of a pad including a plurality of redeemable coupons.

### BRIEF DESCRIPTION OF THE DRAWINGS

FIG. 1 is a front view of a preferred embodiment of the reusable reminder of the present invention;

FIG. 2 is a perspective view of a preferred embodiment of the reusable reminder of FIG. 1;

FIG. 3 is a perspective view of a further preferred embodiment of the present invention; and

FIG. 4 is a perspective view of a most preferred embodiment of the present invention.

### DETAILED DESCRIPTION OF THE PREFERRED EMBODIMENT

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

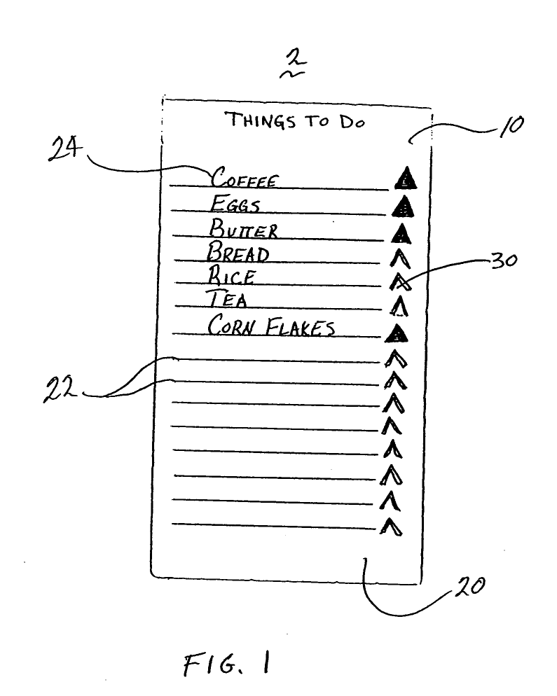

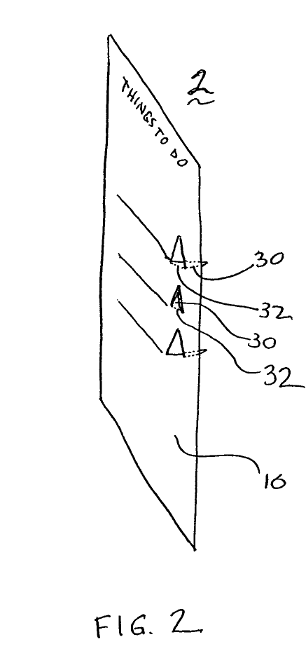

Now referring to FIGS. 1 and 2, the reusable reminder 2 comprises essentially a sheet 10 having an indicia receiving surface 20, said sheet further comprising at least one flexible tab 30 formed therein, said tab formed as a result of punching a portion of said sheet 10. Sheet 10 may further comprise parallel lines 22 such as but not limited to ruled lines for aligning indicia to be listed on receiving surface 20. Preferably said lines are aligned with said tabs 30. Sheet 10 may further comprise bordering, legends or preprinted indicia of any language thereon.

A user uses the reminder 2 by listing items 24 on the indicia receiving surface 20, preferably on lines 22. As items 24 are purchased, collected or performed, the tab 30 corresponding to said item 24 is displaced by pressing same through sheet 10. In this manner, items 24 are “checked off” without the need of a writing instrument. Upon completion of all of the items, the tabs 30 are returned to their original position, making the reminder 2 reusable.

Optionally items 24 such as staple items such as flour, milk, eggs and the like may be preprinted on sheet 10, eliminating the need for the user to rewrite these items 24 each time a new reusable reminder 2 is to be used.

Now referring to FIG. 2, tabs 30 are preferably formed by punching through said sheet leaving the tab attached to said sheet along for example one edge 32. Tab 30 may be folded back manually along edge 32 to indicate an item 24 is satisfied. Tabs 30 may be colored contrasting the remainder of sheet 10.

Such a device is easily and readily usable and capable of reuse. The sheet 10 in a preferred embodiment may further comprise openings for receiving rings of a rings-type binder.

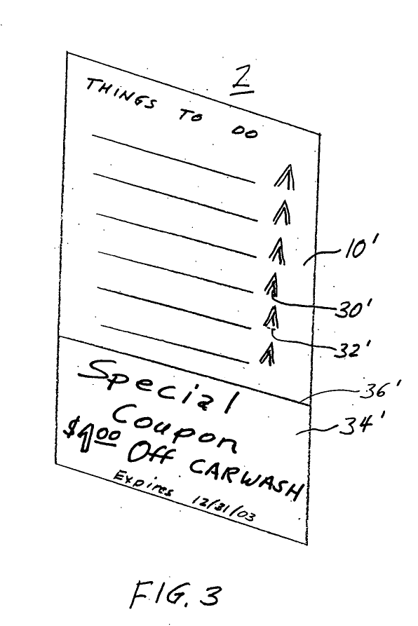

Referring to FIG. 3, a further embodiment of the invention is illustrated with similar numbers to those used in relation to FIGS. 1 and 2, with a prime (′) added to differentiate the present embodiment. The embodiment of FIG. 3 provides an added feature wherein a coupon 34′ is incorporated on the face of sheet 10′ of reminder 2′. The inclusion of coupon 34′ generates an advantage for the supplier of the reusable reminder 2′ as an additional income source and for the user as a discount on needed goods or services. Coupon 34′ is preferably printed at the lower edge of the sheet 10′ and separated from the upper portion by line 36′, which may be perforated or simply printed. Coupon 34′ may be removably adhered to said sheet by use of an appropriate adhesive and release layer.

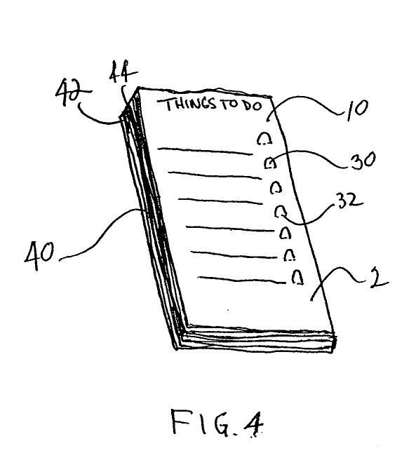

Referring now to FIG. 4, in a most preferred embodiment, a plurality of reminders 2 are provided in the form of a pad 40, bound in a manner well known to those having ordinary skill in the art. The reminders 2 contained in said pad 40 may be identical or comprise different designs, colors, number of tabs 30, or the like. Reproducing means such as but not limited to carbon paper sheets 44 may be disposed between sheets 10 of pad 40. As will be apparent to those skilled in the art, pad 40 may contain sheets 10′ such as are depicted in FIG. 3 that include a coupon 34′. Alternately, coupon 34′ may be included in the last pages of pad 40 or other locations, such as every 4 pages, according to the desires of the maker. The pad 40 in a preferred embodiment may further comprise openings for receiving rings of a rings-type binder. Pad 40 preferably further comprises a means for adhering the pad 40 to a surface, such as but not limited to an adhesive strip or a magnet disposed on the back of said pad 40.

Sheets 10 may be formed of any suitable material such as paper, coated paper, cardstock, and the like.

Adhesive may be disposed on the back of sheet 10. In the embodiment comprising a pad 40 containing a plurality of reminders 2, a cardboard backing 42, may be applied to said pad 40 to provide support for said pad 40.

While the preferred embodiment has been described and illustrated it will be understood that changes in details and obvious undisclosed variations might be made without departing from the spirit and principle of the invention and therefore the scope of the invention is not to be construed as limited to the preferred embodiment.

What is claimed is:

1. A reusable reminder comprising a sheet having an indicia receiving surface, said sheet further comprising a plurality of flexible tabs forms therein, said tabs comprising punched portions of said sheet.

2. The invention according to claim 1 said sheet comprising said tabs oriented horizontally on said sheet.

3. The invention according to claim 1 said sheet comprising said tabs oriented vertically on said sheet.

4. The invention according to claim 3 said indicia receiving surface further comprising horizontal lines, said sheet comprising at least one tab per horizontal line.

5. A reusable reminder device comprising a plurality of sheets, at least one of said sheets having an indicia receiving surface, said sheet further comprising a plurality of flexible tabs formed therein, said tabs comprising punched portions of said sheet.

6. The invention of claim 5 further comprising an indicia reproduction means disposed between at least two of said sheets.

7. The invention of claim 6 said indicia reproduction means comprising carbon paper.

8. The invention of claim 5 further comprising a pad of sheets.

9. The invention of claim 1 comprising a shopping list.

10. The invention of claim 1 comprising a to-do list.

11. A reusable reminder comprising a sheet having an indicia receiving surface, said sheet further comprising a plurality of flexible tabs forms therein comprising punched portions of said sheet, said sheet further comprising at least one redeemable coupon.

12. The reusable reminder as described in claim 11, said reminder comprising a plurality of sheets containing at least one coupon on each sheet.

13. The reusable reminder as described in claim 11, said reminder comprising a pad of sheets containing at least one coupon on at least one of said sheets.

14. The reusable reminder as described in claim 11, said coupon attached to said sheet by a perforated connection.

15. The reusable reminder as described in claim 11 further comprising a plurality of consecutive sheets comprising coupons.

16. The reusable reminder as described in claim 11 comprising a pad of sheets containing at least one coupon and at least one sheet without a coupon.

17. The invention according to claim 1 comprising preprinted indicia.

18. The invention according to claim 1 said sheet comprising at least two openings formed therein for receiving the rings of a ring-type binder.

19. The invention according to claim 5 said plurality of sheets comprising at least two openings formed therein for receiving the rings of a ring-type binder.

20. The invention according to claim 11 said sheet comprising at least two openings formed therein for receiving the rings of a ring-type binder.

21. The invention according to claim 5 further comprising a means for adhering said pad to a surface.

22. The invention according to claim 21 said means for adhering said pad comprising adhesive.

23. The invention according to claim 21 said means for adhering said pad comprising at least one magnet.
